(19) United States
(12) Patent Application Publication
(10) Pub. No.: US 2016/0110833 A1
(43) Pub. Date: Apr. 21, 2016

(54) Occupancy Indicator

(71) Applicant: AT&T Mobility II LLC, Atlanta, GA (US)

(72) Inventors: Jeremy Fix, Acworth, GA (US); George Goehring, Decatur, GA (US); Sheldon Kent Meredith, Roswell, GA (US)

(73) Assignee: AT&T Mobility II LLC, Atlanta, GA (US)

(21) Appl. No.: 14/515,624

(22) Filed: Oct. 16, 2014

(51) Int. Cl. G06Q 50/26; G08B 25/10; G06F 17/30

(52) U.S. Cl. CPC G06Q 50/265; G06F 17/30424; G08B 25/10

(57) ABSTRACT

A count of the occupants of a building is generated at a date and time. As occupants enter the building, a database logs each occupant's entry. The database further logs the current location of each occupant within the building. If an emergency should ever occur, the database reveals an accurate count and listing of the current occupants and their individual locations within the building.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

First responders need accurate information. When emergency personnel encounter a rescue situation, information describing structural buildings and occupants helps focus the rescue efforts. Accurate information fosters quick decisions that save lives.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-4 are simplified schematics illustrating an environment in which exemplary embodiments may be implemented;

FIG. 5 is a more detailed schematic illustrating the operating environments, according to exemplary embodiments;

FIGS. 6-8 are detailed schematics illustrating checkpoint tracking, according to exemplary embodiments;

FIG. 9 is a schematic illustrating a sensor database, according to exemplary embodiments;

FIGS. 10-12 are schematics illustrating a facial recognition system, according to exemplary embodiments;

FIGS. 13-15 are detailed schematics illustrating transceiver recognition, according to exemplary embodiments;

FIG. 16 is a schematic illustrating a mobile occupancy application, according to exemplary embodiments;

FIGS. 17-18 are schematics illustrating infrared detection, according to exemplary embodiments;

FIG. 19 is a schematic illustrating beacon transmission, according to exemplary embodiments;

FIG. 20 is a schematic illustrating redundant elimination, according to exemplary embodiments;

FIG. 21 is a schematic illustrating occupancy of emergency personnel, according to exemplary embodiments;

FIG. 22 is a schematic illustrating mapping features, according to exemplary embodiments;

FIG. 23 is a schematic further illustrating the user database 120, according to exemplary embodiments; and

FIG. 24 depicts still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

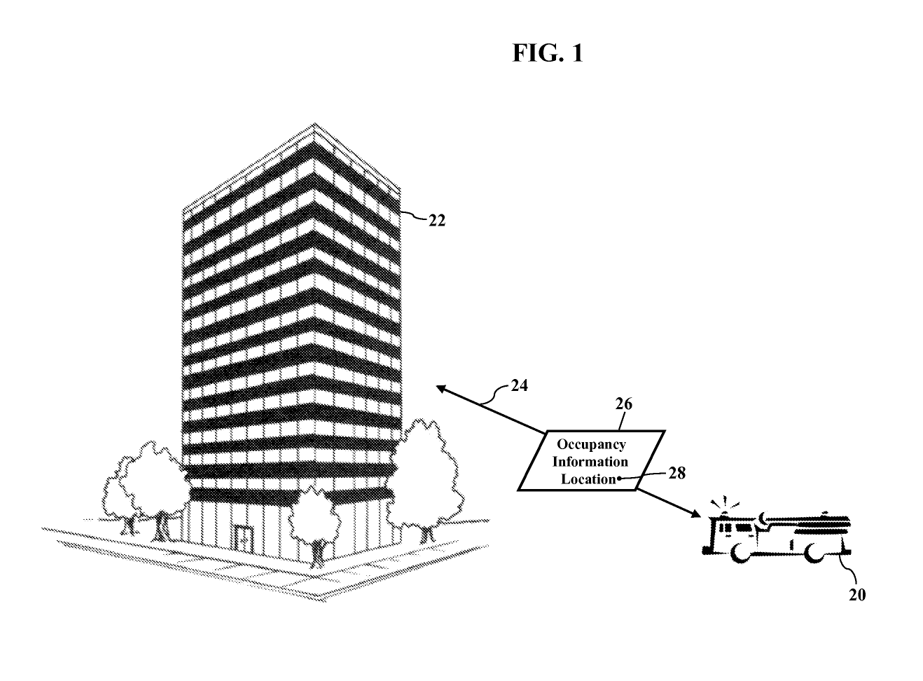

FIGS. 1-4 are simplified schematics illustrating an environment in which exemplary embodiments may be implemented. FIG. 1 illustrates an emergency situation in which first responders 20 arrive at a building 22. Ordinarily the first responders 20 have no knowledge of the structural details of the building 22 and who might be inside. Here, though, an emergency beacon 24 is transmitted for receipt by the first responders 20. The emergency beacon 24 contains occupancy information 26 describing the occupants inside the building 22. That is, the emergency beacon 24 may include a count of the occupants inside the building 22. Indeed, the emergency beacon 24 may even identify the people and pets inside the building 22, along with the current location 28 of each occupant. Moreover, the emergency beacon 24 may also include the structural details describing the building 22. When the first responders 20 receive the emergency beacon 24, the first responders 20 may thus concentrate their rescue efforts on the locations 28 of the occupants.

Exemplary embodiments thus promote quick decisions. As the reader likely understands, when emergency personnel arrive upon a disaster event, quick decisions make a difference between life and death. The emergency beacon 24 provides physical, structural details of the building 22, thus allowing the first responders 20 to accurately navigate their way through stairs and halls to the locations 28 of the occupants. Moreover, the occupancy information 26 may be augmented with names and facial images, thus further enhancing recognition of the occupants. The occupancy information 26 may also be used to retrieve home addresses and other contact information, thus allowing quick notification of loved ones.

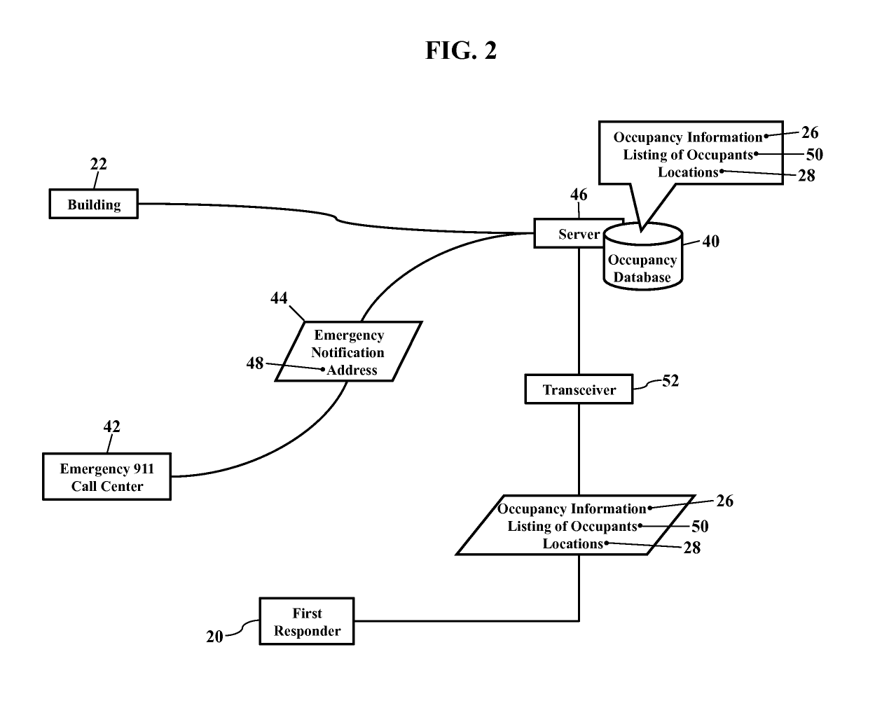

FIG. 2 illustrates an occupancy database 40. The occupancy database 40 stores the names and any other information associated with the occupants of the building 22. For example, suppose an Emergency 911 call center 42 is informed of some emergency situation inside the building 22. The Emergency 911 call center 42 sends an emergency notification 44 to a network address of a server 46 that stores the occupancy database 40. The emergency notification 44 may request identification and a count of the occupants at some street address 48 (such as the building 22 illustrated in FIG. 1). When the server 46 receives the emergency notification 44, the server 46 queries the occupancy database 40 for the street address 48.

The occupancy database 40 stores the occupancy information 26. Once the server 46 knows the street address 48 of the building 22, the server 46 generates a listing 50 of occupants currently located inside or even near the building 22. The listing 50 of occupants may include names, digital images, and any other information identifying the people and pets associated with the street address 48 of the building 22. The listing 50 of occupants is complied from many sources, which later paragraphs will explain. Regardless, the listing 50 of occupants may then be sent to any destination, such as a transceiver 52 for wireless transmission to any recipient. FIG. 2, for simplicity, illustrates the listing 50 of occupants being wirelessly received by the first responders 20.

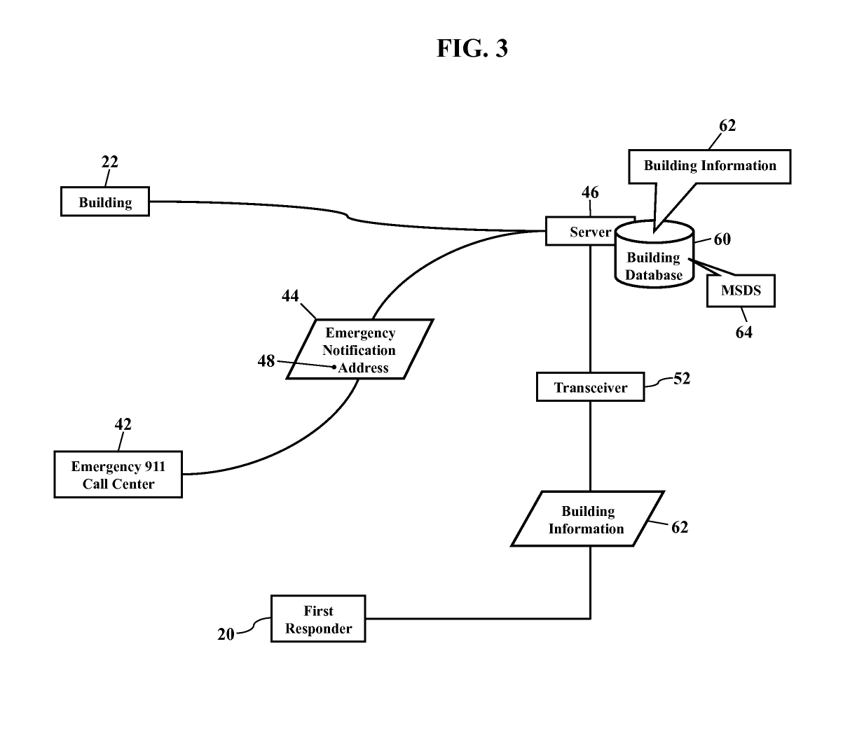

FIG. 3 illustrates a building database 60. The building database 60 stores any information associated with the building 22. FIG. 3, for simplicity, also illustrates the server 46 storing the building database 60, but the building database 60 may be remotely stored and maintained by any processor-controlled device. Whenever the server 46 needs structural, electrical, and mechanical information, the server 46 queries the building database 60 for the street address 48 of the building 22. The server 46 thus retrieves any building information 62 deemed useful in emergency situations. The building information 62, for example, may include digital drawings, maps, and photographs of hallways, floors, and rooms. The building information 62 may also include blueprints, security passwords, sprinkler system locations and details, fire suppressant locations, exit locations, and defibrillator locations. Moreover, the building information 62 may further include material safety data sheets (or “MSDS”) 64 describing safe handling of chemical products located inside the building 22. So, once the street address 48 is known, the building information 62 may be quickly retrieved and sent to any destination, such as the first responders 20.

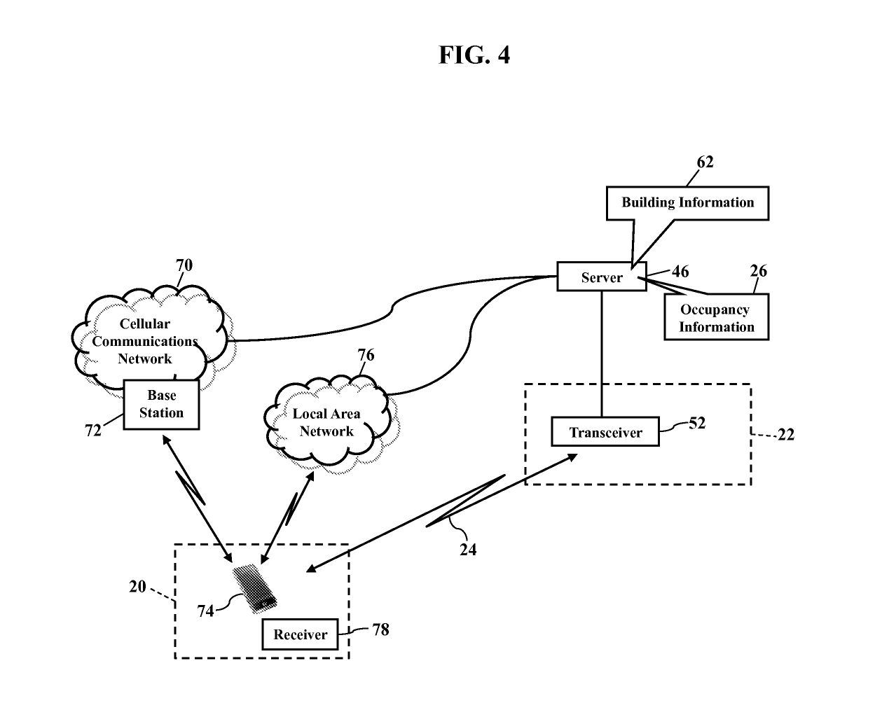

FIG. 4 illustrates networking options. Once the occupancy information 26 and the building information 62 are determined, exemplary embodiments may use any delivery mechanism. FIG. 4, for example, illustrates delivery using a wide area network, such as a cellular communications network 70. The occupancy information 26 and/or the building information 62 may be routed to a cellular base station 72 for transmission to any device, such as a network address associated with a first responder's smartphone 74. A local area network 76 (such as WI-FI®) may also be used to transmit to the first responder's smartphone 74. Indeed, the occupancy information 26 and/or the building information 62 may be routed into a public or private network for delivery to any network address, such as a police or FEMA operations center.

FIG. 4 also illustrates the emergency beacon 24. As the reader may understand, communications may be unavailable during emergency situations, for many reasons. Exemplary embodiments, then, may transmit the occupancy information 26 and/or the building information 62 as content within the emergency beacon 24. The emergency beacon 24 may be transmitted by the transceiver 52, perhaps located in a secure vault or reinforced location within the building 22. The transceiver 52 may broadcast the emergency beacon 24 using a low power mechanism to conserve battery power. As the first responders 20 approach the building 22, an analog or digital receiver 78 receives the emergency beacon 24. However, the emergency beacon 24 may also be received by a satellite and forwarded to emergency personnel. Regardless, the emergency beacon 24 reveals the occupants inside the building 22 and its structural details.

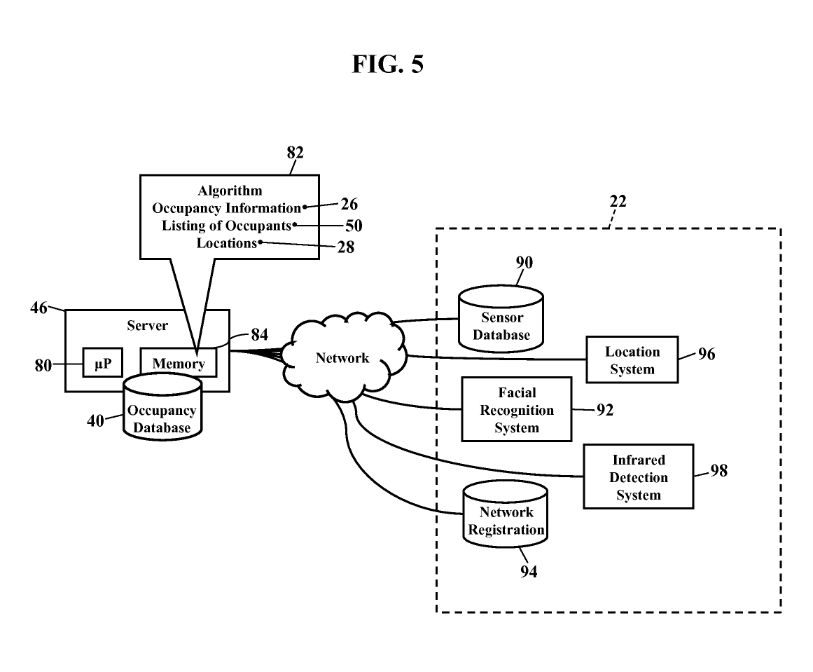

FIG. 5 is a more detailed schematic illustrating the operating environment, according to exemplary embodiments. Here the server 46 collects information from various sources to construct the occupancy database 40. The server 46 has a processor 80 (e.g., “μP”), application specific integrated circuit (ASIC), or other component that executes an algorithm 82 stored in a local memory 84. The algorithm 82 instructs the processor 80 to perform operations, such as querying various databases and systems to determine the listing 50 of occupants inside the building 22. The occupancy database 40, for example, may track electronic badges that enter and exit the building 22. The server 46 may also interface with a sensor database 90 that anonymously tracks people and animals, such as by revolving doors and other occupancy counting measures. The server 46 may also interface with a facial recognition system 92 that recognizes people and animals using security cameras. A network registration database 94 tracks the devices that register with a computer network in the building 22, thus revealing a proxy presence of visitors and registered users. A location system 96 may track the locations 28 of people and mobile devices detected within the building 22. An infrared detection system 98 detects infrared signatures of different devices and users located within the building 22. All these systems and databases will be hereinafter further explained. All these sources may thus be used to keep the occupancy database 40 current with the accurate listing 50 of occupants inside the building 22. The algorithm 82 may thus instruct the server 46 to generate the listing 50 of occupants.

Exemplary embodiments may be applied regardless of networking environment. Exemplary embodiments may be easily adapted to cellular, WI-FI®, and/or BLUETOOTH® networking technologies. Exemplary embodiments may be applied to any processor-controlled devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. The processor 80 may be one or multiple processors, which could include distributed processors or parallel processors in a single machine or multiple machines. The processor 80 may be used in supporting a virtual processing environment. The processor 80 could include a state machine, application specific integrated circuit (ASIC), programmable gate array (PGA) including a Field PGA, or state machine. When any of the processors execute instructions to perform “operations”, this could include the processor 80 performing the operations directly and/or facilitating, directing, or cooperating with another device or component to perform the operations.

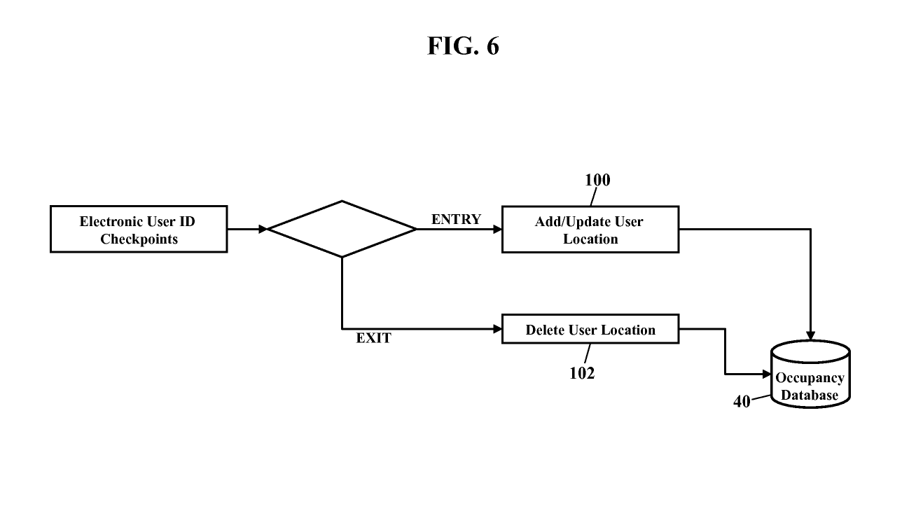

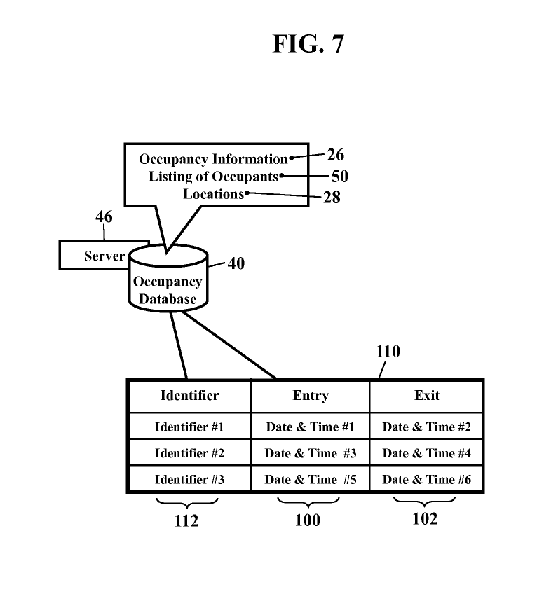

FIGS. 6-8 are detailed schematics illustrating checkpoint tracking, according to exemplary embodiments. The occupancy database 40 may be updated with entries for the names of people and animals entering and/or exiting any area (such as the building 22 illustrated in FIGS. 1-5). As the reader likely knows, many buildings have security measures in which electronic badges, key cards, and/or tokens are required for entry and exit. Each electronic security measure may be associated with a different employee, visitor, or animal. As the electronic security measure passes a checkpoint sensor, each entry 100 and exit 102 may be tracked in the occupancy database 40. FIG. 7 thus illustrates the occupancy database 40 as a table 110 that maps, relates, or associates different identifiers 112 to their respective date and time of entry 100 and corresponding exit 102. Each identifier 112 may be associated with a different person or animal that is authorized for entry into, or exit from, the building 22. The server 46 may thus query the occupancy database 40 for a current date and time, and the occupancy database 40 retrieves the entries having an entry 100 prior to the current date and time but a null or no exit 102. The server 46 thus retrieves the identifiers 12 of the employees, visitors, and/or animals currently logged as occupants.

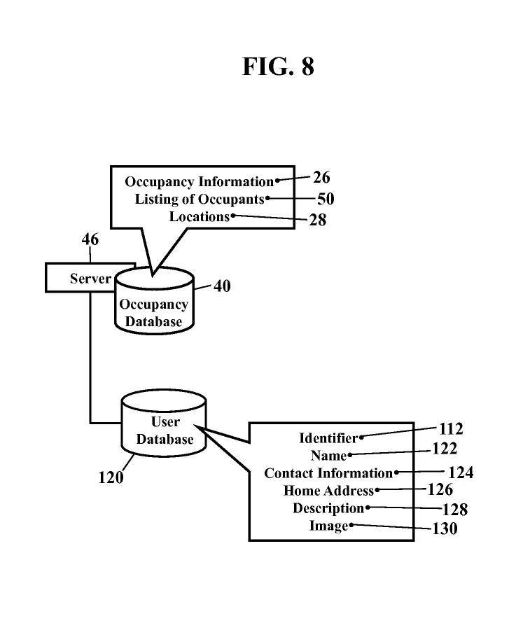

FIG. 8 illustrates a user database 120. The user database 120 stores detailed information for any humans or animals located within the building 22. Even though the server 46 has retrieved the identifiers 112 of the people and animals within the building 22, each identifier 112 is likely a meaningless alphanumeric code that is uniquely assigned. The server 46, then, may query the user database 120 for the identifiers 112 retrieved from the occupancy database 40. The user database 120 thus retrieves detailed information associated with each identifier 112, such as each employee's name 122, contact information 124, home address 126, and physical description 128 (height, weight, hair color, blood type, and/or DNA markers). Indeed, the user database 120 may even contain or store a digital image 130 of the employee. So, once the identifiers 112 of the occupants are known, the server 46 may consult the user database 120 for more detailed, personal information. The server 46 may thus generate the listing 50 of occupants to include names, images, and other personally identifying information.

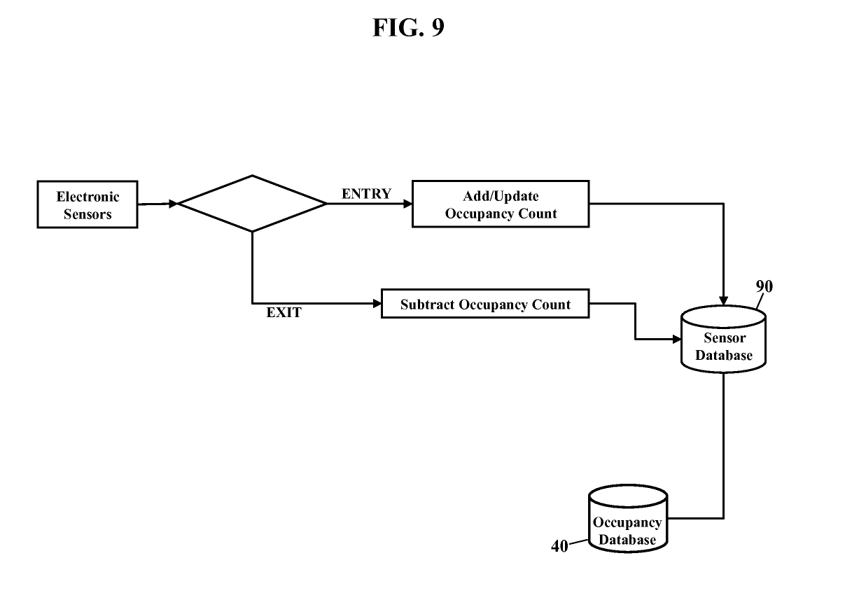

FIG. 9 is a more detailed schematic illustrating the sensor database 90, according to exemplary embodiments. As humans and animals move within the building, various electronic sensors may anonymously log the movement. Sensors, for example, may count the rotations of turnstiles and revolving doors, thus estimating the number of people passing into or out of a room or other area. Financial transactions may be used to estimate the number of people in a cafeteria or gift shop. Elevator stops may be used to estimate the number of people on a floor of the building 22. Whatever information is collected, the sensor database 90 collects anonymous information that is used to further estimate a count of the occupants in the occupancy database 40. As the sensor database 90 stores anonymous information, exemplary embodiments may thus estimate the number of people in publically accessible spaces, such as a lobby or courtyard. The occupancy database 40 may thus contain an accurate count of people, even if anonymous.

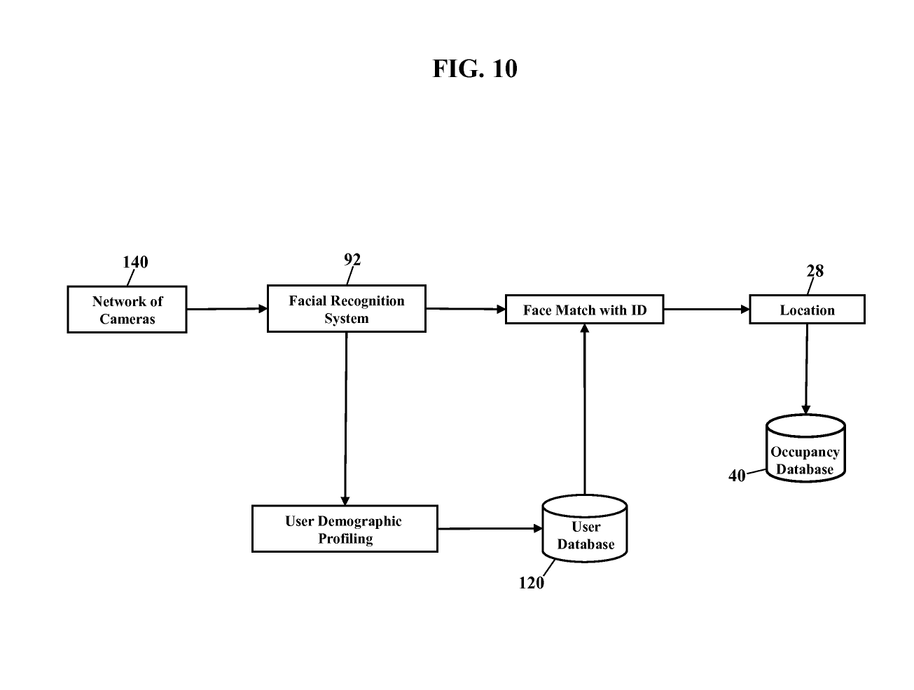

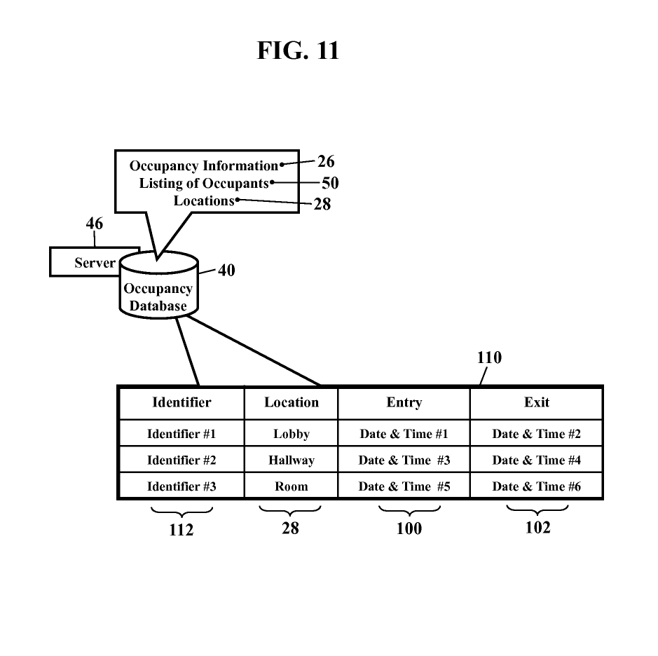

FIGS. 10-12 are detailed schematics illustrating the facial recognition system 92, according to exemplary embodiments. As the reader again understands, many buildings have a network 140 of security cameras that capture digital images of a lobby, hallways, and rooms. The facial recognition system 92 may thus access outputs from these cameras to identify individual people and animals within the building 22. Indeed, the user database 120 may store facial descriptors and/or demographic profiles associated with individual persons within the building 22. When facial recognition is successful, the occupancy database 40 may be updated to include the current location 28 of the employee or other recognized person. FIG. 11, for example, illustrates the occupancy database 40 mapping the location 28 associated with each occupant identifier 112. When a particular camera captures an image of the employee, the occupancy database 40 may log the physical location 28 of the camera to the employee's unique identifier 112. The location 28 of the employee may thus be pinpointed to a particular floor, hall, or even room within the building 22. Indeed, as the employee walks or moves within the building 22, the server 46 may use the facial recognition system 92 to track the employee's current location 28, based on which camera captures the employee's image. The occupancy database 40 may thus log the physical location 28 of any recognized human or animal, at any time.

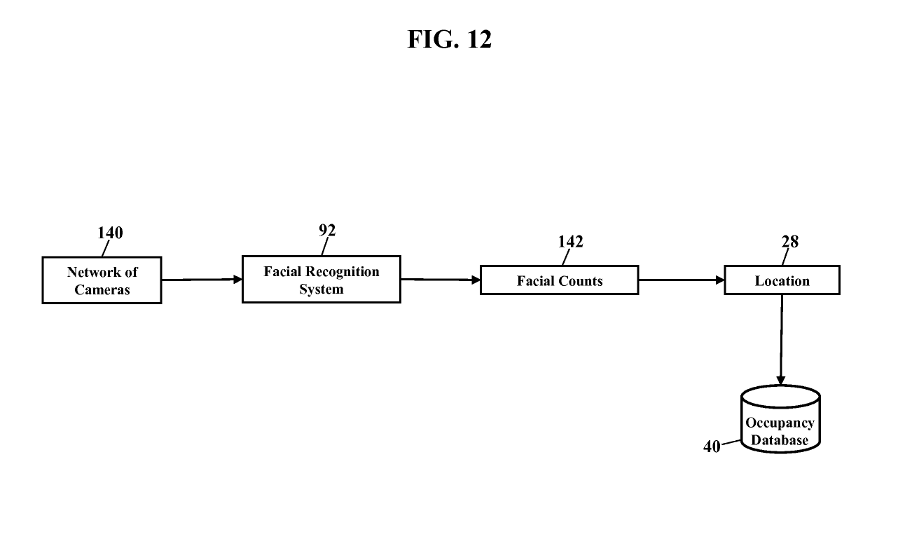

FIG. 12 further illustrates anonymous counts. As people gather in lobbies, courtyards, and other public spaces, the network 140 of security cameras captures images of the faces. Even if the facial recognition system 92 does not recognize some faces, exemplary embodiments may still count the number of anonymous faces (Block 142) in a location 28. The occupancy database 40 may thus contain an accurate count of people and animals, even if individual faces are not recognized. Exemplary embodiments may thus add or sum the number of anonymous faces to determine the total occupancy in the occupancy database 40.

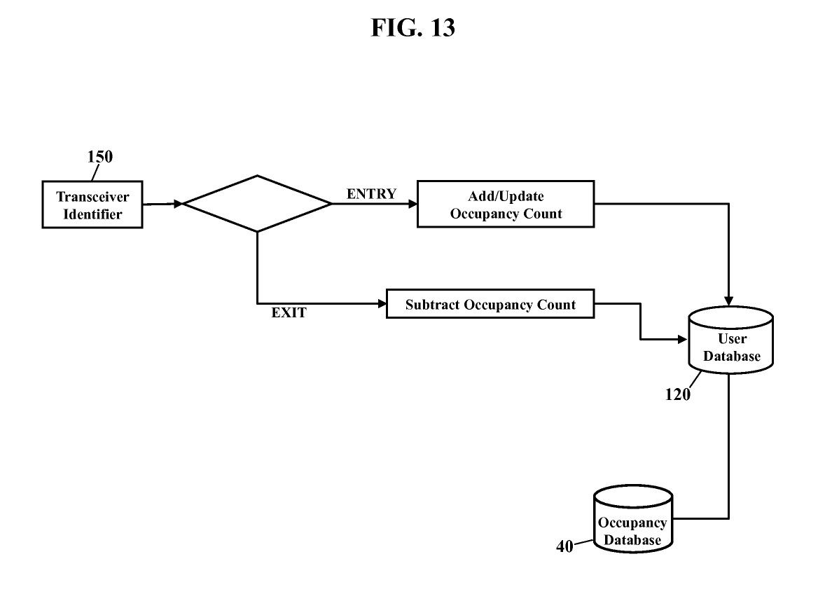

FIGS. 13-15 are detailed schematics illustrating transceiver recognition, according to exemplary embodiments. Whenever any device transmits electromagnetic signals, exemplary embodiments may identify and log the corresponding transceiver. Again, many buildings have electronic scanners or other transceivers at entry and exit points. Whenever a mobile device (such as a smartphone) passes, signals may be exchanged. Exemplary embodiments may thus identify each mobile device by a unique transceiver identifier 150. Whenever a signal is received, each entry and exit may be logged in the occupancy database 40 and used to update the occupancy count. Because each mobile device has the unique transceiver identifier 150, each entry and exit may be associated with the corresponding employee or authorized visitor, as matched to the user database 120. Exemplary embodiments may thus identify and log any transmission using any frequency in the electromagnetic spectrum, such as IBEACON®, BLUETOOTH®, WIFI®, and cellular transmissions.

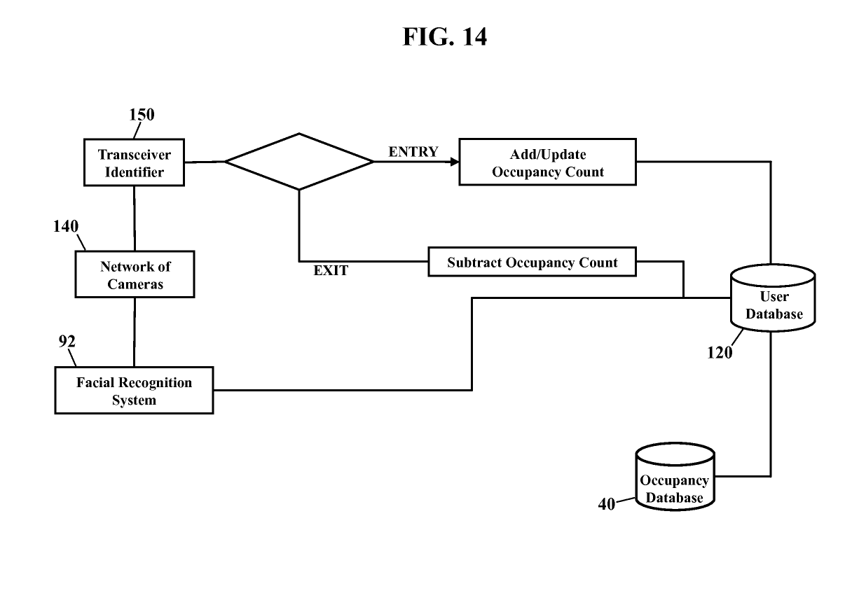

FIG. 14 illustrates identification of a new occupant. There will be times when the unique transceiver identifier 150 is not recognized. For example, an unknown visitor's mobile device may be detected, or an employee may purchase a new smartphone, smartwatch, or other mobile device. When signals are received from an unknown transceiver, the transceiver identifier 150 will likely be new and unrecognized. However, exemplary embodiments may perform an automatic update to the user database 120. When the transceiver identifier 150 is unknown, exemplary embodiments may instruct the network 140 of security cameras to obtain a facial image of the corresponding user. For example, whatever receiver detects the new, unrecognized transceiver identifier 150, a corresponding camera may be instructed to capture the facial image of the corresponding user. The facial recognition system 92 analyzes the facial image and may compare facial attributes to the user database 120. If the facial image matches an entry in the user database 120, the new transceiver identifier 150 may be associated with the corresponding user, thus acting as a proxy. The occupancy database 40 may thus be updated, based on the new transceiver identifier 150 associated with the recognized employee or visitor.

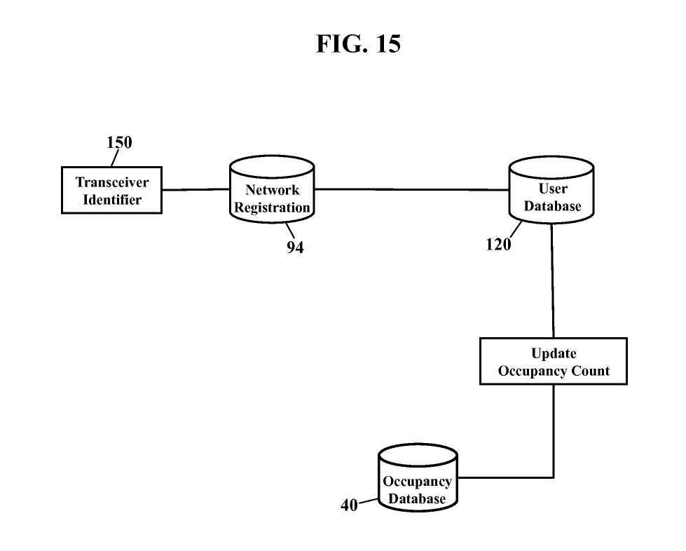

FIG. 15 illustrates the network registration database 94. As the reader likely understands, devices usually must register to access a wired or wireless network. Each registration may thus reveal the presence of a visitor or a registered user. Again, each unique transceiver identifier 150 may be associated with a single user in the user database 120. The total number of registrations may thus be used as a further estimate of the occupancy count for the number of people or animals in the building 22. If a person has multiple devices, duplicate counts may be reconciled to account for only a single user.

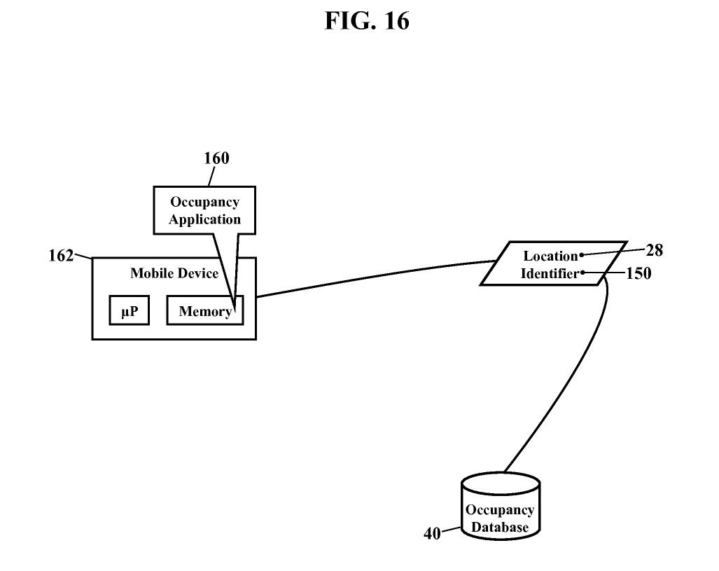

FIG. 16 is a schematic illustrating an occupancy application 160, according to exemplary embodiments. As the reader again likely understands, mobile devices may download many different software applications for many different uses. Here, then, a user may download the occupancy application 160 to her mobile device 162, thus keeping the occupancy database 40 updated with her current location 28. For example, the user's mobile smartphone may execute the mobile application 160 and periodically transmit its unique transceiver identifier 150 and location 28 to a network address associated with the occupancy database 40. The mobile application 160 thus cooperates with the occupancy database 40 to log the entries, exits, and other locations of the mobile device 162, which acts as a proxy for the user. If global positioning system information is unavailable, exemplary embodiments may determine the location 28 using network hotspots or any other location technology. As the mobile device 162 moves, the occupancy database 40 is thus updated with the current location 28.

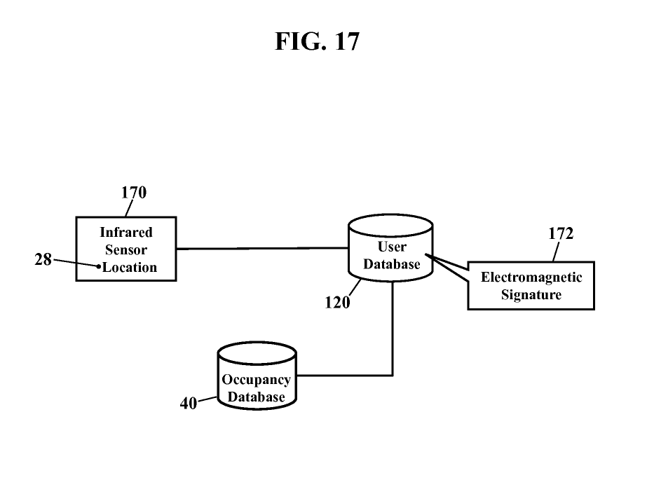

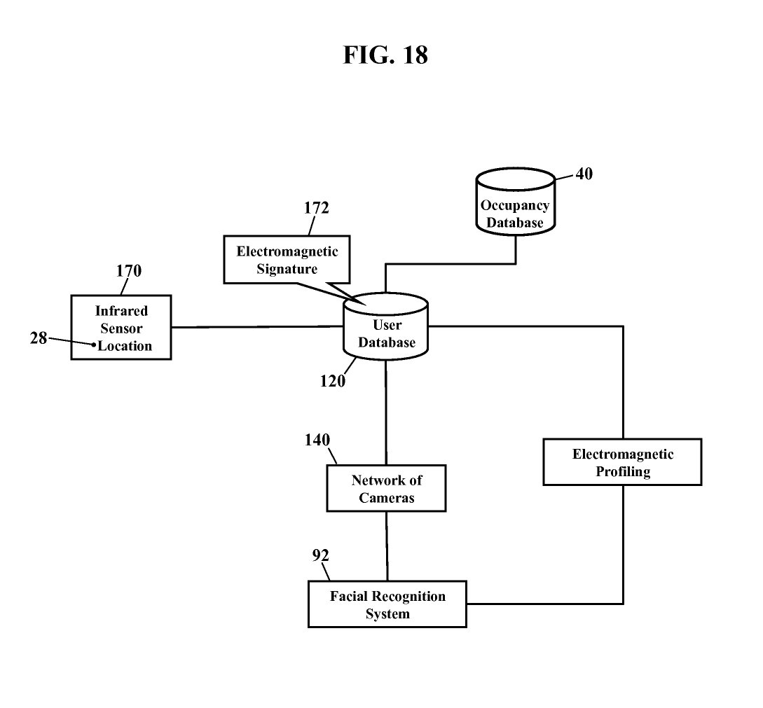

FIGS. 17-18 are schematics illustrating infrared detection, according to exemplary embodiments. Here exemplary embodiments may update the occupancy database 40, based on infrared recognition. An infrared sensor 170 receives a signal at a frequency in the infrared portion of the electromagnetic spectrum. The signal is compared to an electromagnetic signature 172 stored in the user database 120. Each user's account in the user database 120, in other words, may include infrared or other electromagnetic signatures of devices and his/her human body. If the signal matches an entry in the user database 120, the occupancy database 40 is updated with the corresponding user. The location 28 of the infrared sensor 170 may also be associated with the user. A user's infrared body emission(s) may thus be uniquely identified, revealing the presence of a recognized person.

Infrared detection may indicate occupancy. The infrared sensor 170 may be located in any area or room, thus detecting presence of humans and animals. Even if an infrared signal cannot be recognized, the signal still indicates the presence of some life form. The occupancy database 40, then, may still be updated to indicate the corresponding area or room is occupied, even though the number of occupants and identities may be unknown. However, if the signal is no longer detected, exemplary embodiments may determine that the area/room is unoccupied and update the occupancy database 40 accordingly. Exemplary embodiments, for example, may initialize a timer that counts up or down to a final value. When the timer expires, exemplary embodiments may again query for or read an output from the infrared sensor 170. As long as the infrared sensor 170 produces or generates an output, the area or room may be occupied and the occupancy database 40 is updated. However, if the infrared sensor 170 provides no output or a low output, the area/room is likely unoccupied and the occupancy database 40 is again updated. Emergency responders may thus be informed of occupied areas, even though identification may be unavailable.

FIG. 18 also illustrates new user identification. Again, the infrared sensor 170 may sometimes receive signals that are unknown or not recognized. When the signal is not matched to the user database 120, exemplary embodiments may use the network 140 of cameras and the facial recognition system 92 to recognize the facial images captured by one of the cameras in the corresponding area/room. If facial recognition fails to determine a match, exemplary embodiments may use electromagnetic profiling. For example, each human, animal, or object may emit a unique electromagnetic signature, such as an infrared emission detected by the infrared sensor 170. The output of the infrared sensor 170 may thus be compared to electromagnetic signatures 172 or other characteristics stored in the user database 120. The user database 120 may thus store electromagnetic features, values, or parameters that are associated to different categories and demographics. When the infrared sensor 170 generates its output signal, the output signal may be compared to the entries in the user database 120. If a match is determined, the corresponding category or demographic may be retrieved, thus further revealing the presence and location 28 of an identified life form. The occupancy database 40 may then again be updated to indicate the location 28 of any life form. Exemplary embodiments may thus use demographic profiling, unsupervised clustering techniques, and supervised classification techniques to catalog different infrared signatures through commonalities. Different user demographic profiles may be stored in the user database 120. Whenever an infrared or other electromagnetic signature is identified, the signature is used to perform a location update for the identified life form and thus update the occupancy database 40.

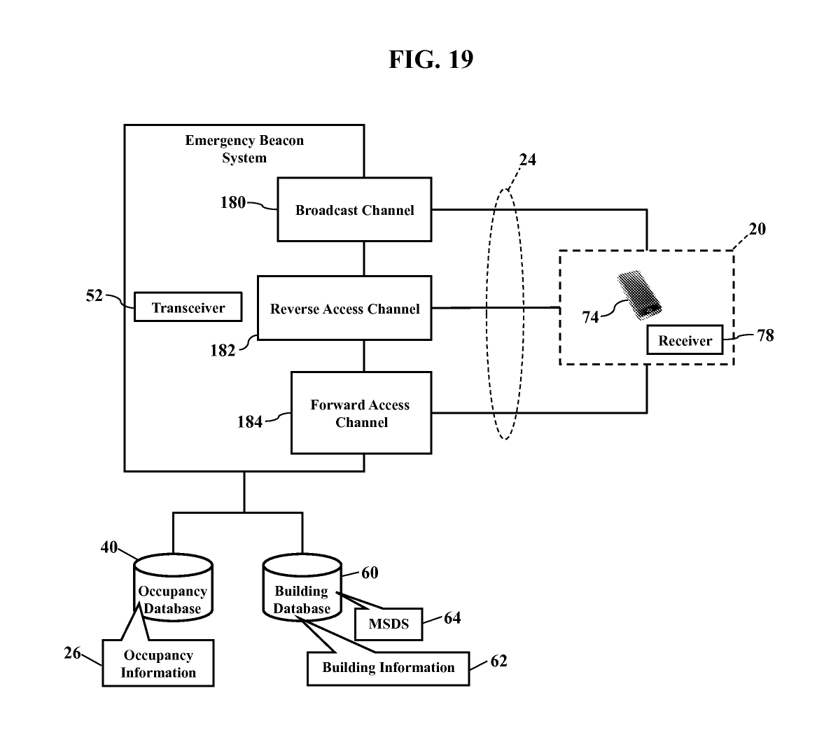

FIG. 19 is a schematic further illustrating beacon transmission, according to exemplary embodiments. At any time exemplary embodiments may be instructed to broadcast the emergency beacon 24, but certainly in times of need. FIG. 19, for example, illustrates the transceiver 52 broadcasting the emergency beacon 24 to the emergency responder 20 (such as the responder's smartphone 74 or other receiver 78). The emergency beacon 24 may be transmitted as an ongoing broadcast in the emergency area. The transceiver 52, for example, may broadcast the emergency beacon 24 using a broadcast channel 180, which is commonly used in emergency situations. The broadcast channel 180 may include instructions for synchronization with a reverse access channel 182 to permit two-way communication. The reverse access channel 182 allows the transceiver 52 to monitor for a request to access the emergency beacon 24. Once the transceiver 52 receives a request on the reverse access channel 182, an acknowledgement for access is transmitted over the broadcast channel 180. The transceiver 52 may thus commence two-way communication with the emergency responder's wireless device 74 or 78 using a forward access channel 184 and the reverse access channel 182. The emergency responder's device 74 or 78 may then send a request for the current status of the occupants, as recorded in the occupancy database 40. Exemplary embodiments retrieve the occupancy information 26, as of the current date and time, perhaps along with the building information 62 and the material safety data sheets (or “MSDS”) 64 retrieved from the building database 60. The emergency beacon 24 may then be transmitted to include the occupancy information 26, the building information 62, and the material safety data sheets 64 as informational content.

Emergency personnel are thus apprised of the situation. The emergency responder's wireless device 74 or 78 receives an overview of the occupants within specific rooms or areas, perhaps including individual identification of humans and animals. Even if identification is not available, exemplary embodiments may still provide demographics, visual representations from cameras, and even the unique transceiver identifiers 150 (such as telephone numbers or IP addresses, as reported by each mobile occupancy application 160 illustrated in FIG. 16). Emergency responders may thus establish communication with any identified mobile device. The emergency responder's wireless device 74 or 78 thus provides an occupancy to building safety correlation view, as well as an occupancy to MSDS potential contact view. Exemplary embodiments thus allow emergency personnel to have accurate accounts of the whereabouts of the occupants in the event of a disaster (whether natural, terrorist, or other emergency).

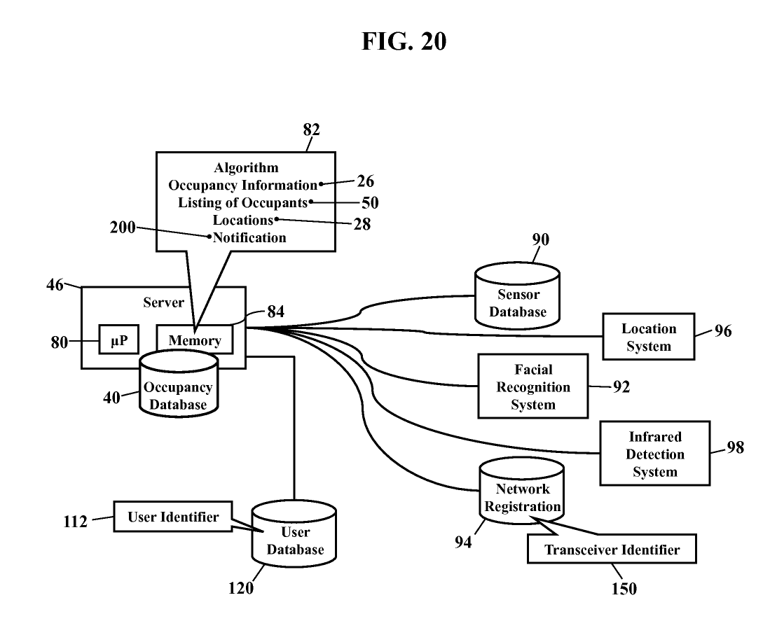

FIG. 20 is a schematic illustrating redundant elimination, according to exemplary embodiments. Exemplary embodiments provide an accurate estimation of the count of occupants in the building 22 or other area. The server 46 collects information from the various sources to update the occupancy database 40 with the occupancy information 26, the listing 50 of the occupants, and their current locations 28. Sometimes, though, there may be a double or even triplicate count. For example, an employee's electronic badge may be recorded in the occupancy database 40, while her face is also recognized by the facial recognition system 92. There is thus a possible double count of the same employee. Similarly, if the employee's wireless device registers in the network registration database 94, there is a possible triple count of the same employee. These redundant counts potentially reduce the accuracy of the occupancy count in the occupancy database 40.

Exemplary embodiments reduce or eliminate excessive counts. Whenever the facial recognition system 92 recognizes a facial image, the facial image has been matched to a known entry in the user database 120. The algorithm 82 may thus check the occupancy database 40 to determine of the same employee or visitor is already logged as an occupant. The server 46, for example, may retrieve the unique identifier 112 from the user database 120, in response to the match. Recall that the identifier 112 uniquely identifies the employee or visitor in the user database 120. The server 46 may then query the occupancy database 40 for the same identifier 112. The server 46 may alternatively query for the name or facial image associated with the employee or visitor. Regardless, if the identifier 112 is matched to an entry in the occupancy database 40, then the employee/visitor is already logged into the occupancy database 40. The algorithm 82, then, does not include the facial match (determined by the facial recognition system 92) in the occupancy count. That is, the employee/visitor has already been included in the occupancy count, based on the entry in the occupancy database 40. The algorithm 82, in other words, disregards the facial match as a double count.

If the user identifier 112 does not match to an entry in the occupancy database 40, the algorithm 82 may have a decision analysis. For example, if the employee's face has been recognized as being an occupant of the building, but the employee's electronic badge is not logged into the occupancy database 40, then there may be a problem with the employee's electronic badge. The algorithm 82 may thus generate a notification 200 that is sent to network addresses associated with the employee and/or security. If electronic badges and other electronic security measures are not used, then the facial recognition may be legitimate, so the algorithm 82 updates the occupancy database 40. That is, an entry is added to the occupancy database 40 that logs the user identifier 112 as a current occupant.

Redundant network registration may be ignored. Whenever a wireless device registers in the network registration database 94, the wireless device may be recognized by its unique transceiver identifier 150 or IP address. The network registration database 94 may thus map the transceiver identifier 150 or the IP address to the corresponding user identifier 112. Alternatively, the transceiver identifier 150 or IP address may be sent to the user database 120 for matching to the corresponding user identifier 112. Regardless, the algorithm 82 may again check the occupancy database 40 to determine if the same employee or visitor is already logged as an occupant. If the user identifier 112 is matched to an entry in the occupancy database 40, then the employee/visitor is already logged as an occupant. The algorithm 82, then, does not include the network registration in the occupancy count. The algorithm 82 disregards the network registration as a double count. If the user identifier 112 does not match to an entry in the occupancy database 40, then there may be a problem with the employee's electronic badge, so the notification 200 may be sent. If electronic badges and other electronic security measures are not used, then the network registration may be legitimate, so the algorithm 82 updates the occupancy database 40. That is, an entry is added to the occupancy database 40 that logs the user identifier 112 as a current occupant.

Similar redundancy may be ignored. If the infrared detection system 98 recognizes the infrared emissions of a known employee or visitor, the occupancy database 40 may be checked to determine if the same employee or visitor is already logged as an occupant. If a match is found, then the employee/visitor is already logged as an occupant and the infrared match is not included in the occupancy count. However, if the corresponding user identifier 112 is not matched to occupancy database 40, then again there may be a problem with the employee's electronic badge, so the notification 200 may be sent. If electronic badges and other electronic security measures are not used, then the infrared match may be legitimate, so the algorithm 82 updates the occupancy database 40 with an entry that logs the user identifier 112 as a current occupant.

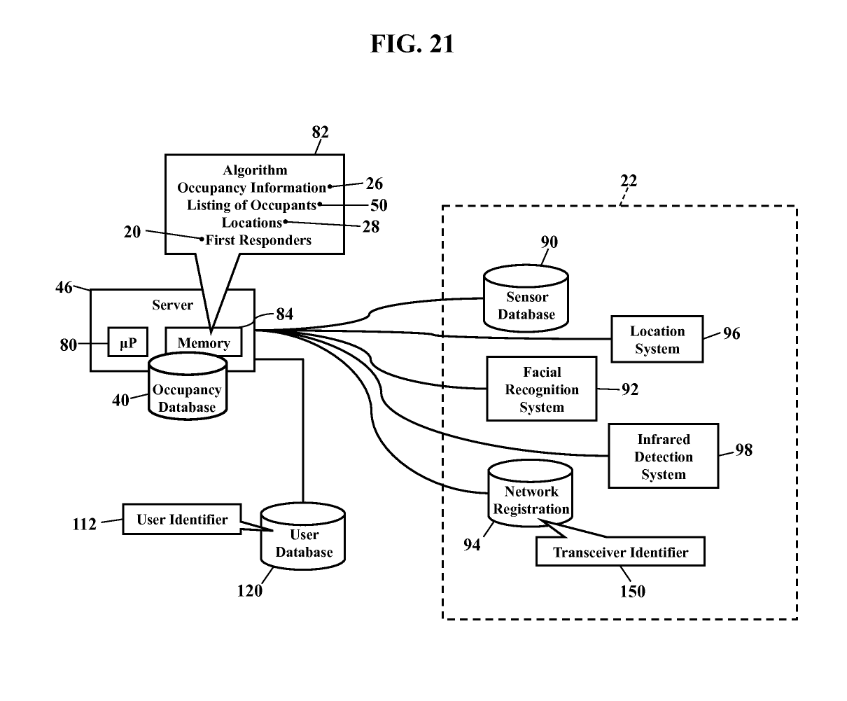

FIG. 21 is a schematic illustrating occupancy of the responders 20, according to exemplary embodiments. When an emergency situation occurs, the emergency personnel risk their lives by rushing into dangerous situations. Here, then, exemplary embodiments may be applied to the first responders 20 and other personnel that enter the building 22. That is, the occupancy database 40 may be updated with the identities and the locations 28 of the emergency personnel who enter the dangerous area. Each first responder, as an example, may have the electronic badge or other device that may be wirelessly tracked and logged in the occupancy database 40. If the emergency personnel carry mobile devices (such as smartphones or radios), their corresponding unique transceiver identifiers 150 may be registered in the network registration database 94 and logged in the occupancy database 40. Their faces may be recognized by the facial recognition system 92 and, thus, tracked in the occupancy database 40. Exemplary embodiments, in short, may update the occupancy database 40 with the identities and the locations 28 of the emergency personnel. The listing 50 of the occupants may thus include the names and whereabouts of the brave first responders.

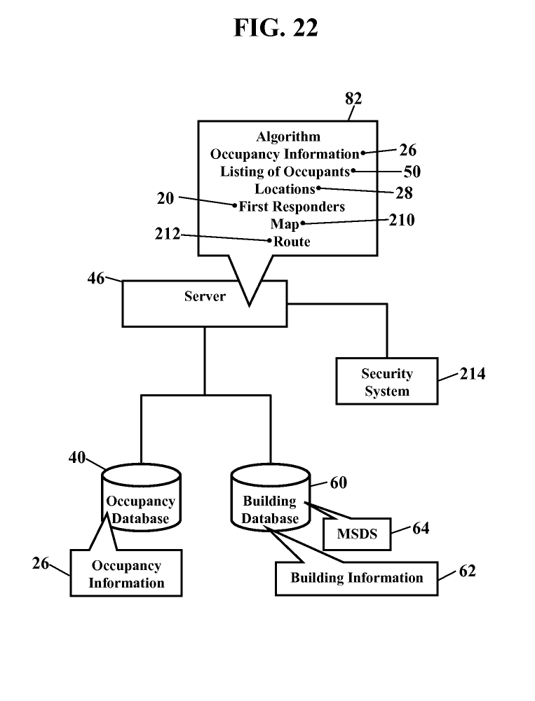

FIG. 22 is a schematic illustrating mapping features, according to exemplary embodiments. Exemplary embodiments update the occupancy database 40 to include the identifies and the locations 28 of both the victims and the first responders 20. Because each occupant's location 28 is individually known, exemplary embodiments may include mapping capabilities. That is, the algorithm 82 may retrieve any occupant's location 28 from the occupancy database 40. The algorithm 82 may also retrieve the building information 62 from the building database 60. The algorithm 82 may thus generate a map 210 of any occupant's current location 28 within the building. More importantly, though, the algorithm 82 may also generate a route 212 from a victim to emergency personnel. That is, as each person's current location 28 is known, exemplary embodiments may plan the route 212 from a victim's current location 28 to the location 28 of a first responder 20. Because the occupancy database 40 logs both the victims (those occupants before the date and time of the emergency) and the emergency personnel (those entering after the date and time of the emergency), exemplary embodiments may generate the route 212 between the locations 28 of any two or more occupants. The route 212 may guide either occupant through rooms, halls, and stairs, according to the architectural and structural details provided by the building information 62. The route 212 may be sent in packets, a message, or any transmission to any network address associated with a victim's mobile device and/or to a first responder's mobile device. The route 212 may identify a central coordination location or other destination, such as an exit, emergency shelter, or aid station. The route 212 may have audible and visual components, thus leading a person through thick smoke and dust. The route 212 may even avoid areas or zones of intense heat, smoke, or destruction, as revealed by an interface with the security system 214.

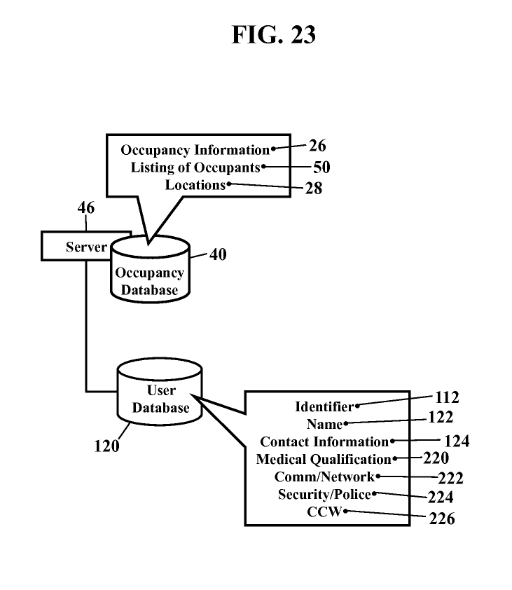

FIG. 23 is a schematic further illustrating the user database 120, according to exemplary embodiments. Here the user database 120 may include personal and professional information that may be useful in emergency information. For example, each user's entry may include a medical qualification 220 indicating some skill or knowledge, such as CPR or first aid training Indeed, the medical qualification 220 may even indicate medical training, such as nurse or physician qualification. When emergency situations occur, the user database 120 may thus be queried for the name 122 and contact information 124 of those occupants with medical training The emergency personnel, for example, may immediately call or text the occupants with the medical qualification 220 for first hand reports and assessments.

Other qualifications are just as important. The occupants with communications and/or networking skills 222 may be contacted to help re-establish communications. Occupants with security and/or police 224 training may be contacted for fast entry and panic control. In perhaps extreme situations, those with a concealed carry weapons permit 226 may be contacted for action.

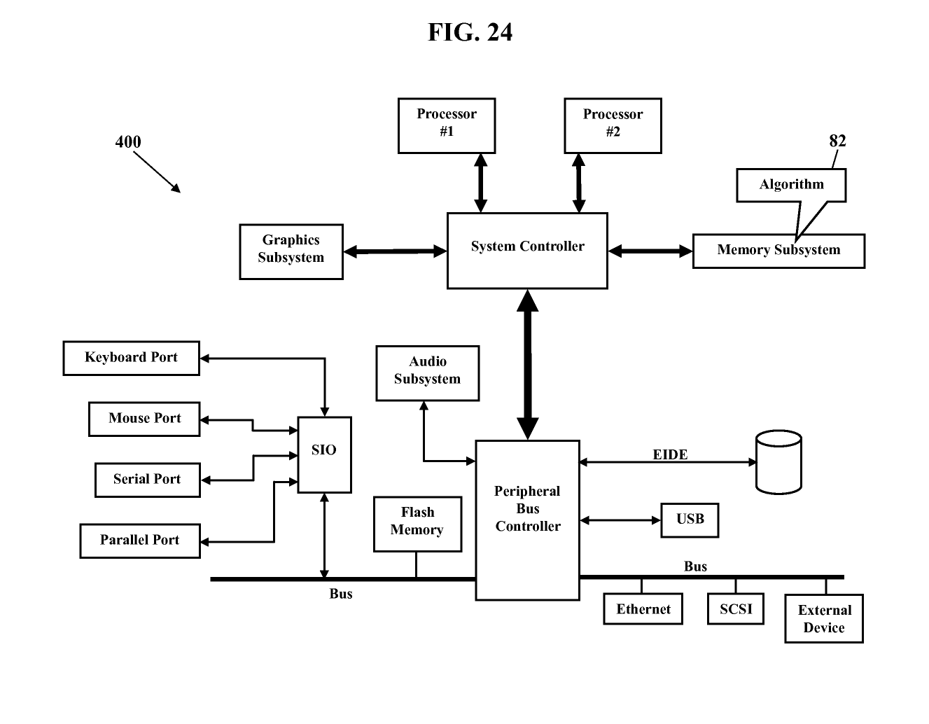

FIG. 24 is a schematic illustrating still more exemplary embodiments. FIG. 24 is a more detailed diagram illustrating a processor-controlled device 400. As earlier paragraphs explained, the algorithm 82 may operate in any processor-controlled device. FIG. 24, then, illustrates the algorithm 82 stored in a memory subsystem of the processor-controlled device 400. One or more processors communicate with the memory subsystem and execute either, some, or all applications. Because the processor-controlled device 400 is well known to those of ordinary skill in the art, no further explanation is needed.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for occupancy indications, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A system, comprising:
a processor; and
a memory storing instructions that when executed cause the processor to perform operations, the operations comprising:
receiving a request for a count of occupants of a building at a date and time;
querying a database for the date and time, the database logging dates and times the occupants enter the building;
generating the count of the occupants entered as of the date and time; and
sending the count of the occupants in response to the request.

2. The system of claim 1, wherein the operations further comprise sending the count of the occupants to a network address associated with a wireless transmitter.

3. The system of claim 2, wherein the operations further comprise wirelessly broadcasting the count of the occupants as informational content in an emergency beacon.

4. The system of claim 1, wherein the operations further comprise generating a listing of the occupants as of the date and time.

5. The system of claim 4, wherein the operations further comprise sending the listing of the occupants to a network address associated with a wireless transmitter.

6. The system of claim 5, wherein the operations further comprise wirelessly broadcasting the listing of the occupants as informational content in an emergency beacon.

7. The system of claim 1, wherein the operations further comprise retrieving a location within the building for each one of the occupants at the date and time.

8. A method, comprising:
receiving, at a server, a request for a count of occupants of a building at a date and time;
querying a database for the date and time, the database logging dates and times the occupants enter the building;
generating, by the server, the count of the occupants entered as of the date and time; and
sending, from the server, the count of the occupants in response to the request.

9. The method of claim 8, further comprising sending the count of the occupants to a network address associated with a wireless transmitter.

10. The method of claim 9, further comprising wirelessly broadcasting the count of the occupants as informational content in an emergency beacon.

11. The method of claim 8, further comprising generating a listing of the occupants as of the date and time.

12. The method of claim 11, further comprising sending the listing of the occupants to a network address associated with a wireless transmitter.

13. The method of claim 12, further comprising wirelessly broadcasting the listing of the occupants as informational content in an emergency beacon.

14. The method of claim 8, further comprising retrieving from the database a location within the building for each one of the occupants at the date and time.

15. A memory storing instructions that when executed cause a processor to perform operations, the operations comprising:
receiving a request for a count of occupants of a building at a date and time;
querying a database for the date and time, the database logging dates and times the occupants enter the building;
generating the count of the occupants entered as of the date and time; and
sending the count of the occupants in response to the request.

16. The memory of claim 15, wherein the operations further comprise sending the count of the occupants to a network address associated with a wireless transmitter.

17. The memory of claim 16, wherein the operations further comprise wirelessly broadcasting the count of the occupants as informational content in an emergency beacon.

18. The memory of claim 17, wherein the operations further comprise generating a listing of the occupants as of the date and time.

19. The memory of claim 18, wherein the operations further comprise wirelessly broadcasting the listing of the occupants as informational content in an emergency beacon.

20. The memory of claim 15, wherein the operations further comprise retrieving a location within the building for each one of the occupants at the date and time.
